(19) United States
(12) Patent Application Publication
(10) Pub. No.: US 2009/0324243 A1
(43) Pub. Date: Dec. 31, 2009

(54) SCALABLE LOAD-BALANCED INTERCONNECT SWITCH BASED ON AN OPTICAL SWITCH FABRIC HAVING A BANK OF WAVELENGTH-SELECTIVE SWITCHES

(75) Inventor: David Thomas Neilson, Old Bridge, NJ (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: LUCENT TECHNOLOGIES INC., Murray Hill, NJ (US)

(21) Appl. No.: 12/164,575

(22) Filed: Jun. 30, 2008

(51) Int. Cl. H04B 10/00

(52) U.S. Cl. 398/154

(57) ABSTRACT

According to one embodiment, an interconnect switch has an optical switch fabric (OSF) having N input ports and N output ports. The OSF has a bank of optically interconnected wavelength-selective switches and is adapted to route optical signals from the input ports to the output ports. In a fully deployed implementation, the interconnect switch has N input line cards and N output line cards. Each of the input line cards is adapted to generate N respective modulated optical signals using carrier wavelengths that are controllably selected from more than N carrier wavelengths to provide wavelength redundancy for optically connecting the input line card and any of the output line cards. In a partially deployed implementation, the interconnect switch has fewer than N input line cards and/or fewer than N output line cards. In either the fully deployed implementation or a partially deployed implementation, the interconnect switch is capable of load balancing.

### CROSS-REFERENCE TO RELATED APPLICATIONS

The subject matter of this application is related to that of U.S. patent application Ser. No. ______, filed on the same date as the present application, identified by attorney docket reference Neilson 27, and entitled “Scalable Load-Balanced Interconnect Switch Based on an Arrayed Waveguide Grating,” which application is incorporated herein by reference in its entirety.

### BACKGROUND OF THE INVENTION

1. Field of the Invention

The present invention relates to optical communication equipment and, more specifically, to optical interconnect switches.

2. Description of the Related Art

This section introduces aspects that may help facilitate a better understanding of the invention(s). Accordingly, the statements of this section are to be read in this light and are not to be understood as admissions about what is in the prior art or what is not in the prior art.

A load-balanced interconnect switch operates by distributing traffic received over any of its input lines evenly over all of its output lines. For example, if an input line delivers incoming traffic at rate R and there are N output lines, then the load-balanced interconnect switch distributes that traffic between the output lines so that the corresponding output rate at each output line is R/N. If the switch has N input lines, each delivering incoming traffic at rate R, then the output rate at each of the N output lines is also R, with each particular input line being responsible for the respective I/N-th share of that rate.

A load-balanced interconnect switch is advantageously capable of providing a 100% throughput guarantee for most types of incoming traffic without employing a switch-fabric scheduler, e.g., because it can spread the incoming traffic over multiple virtual output queues and service each of those queues at an appropriate fixed rate. If the inputs and outputs are not over-subscribed, then, over a sufficiently long period of time, the number of service opportunities for each of the virtual output queues will exceed or match the number of arrivals, thereby enabling 100% throughput. A rigorous proof of this property is outlined, e.g., in an article by I. Keslassy, et al., “Scaling Internet Routers Using Optics,” ACM SIGCOMM'03, Karlsruhe, Germany, Aug. 25-29, 2003, which article is incorporated herein by reference in its entirety.

A typical prior-art load-balanced optical interconnect switch is implemented based on a uniform mesh of fibers or wavelengths. One known problem with this prior-art architecture is that the switch operates properly only if all its line cards are present and operable. However, for economic and/or logistical reasons, a network operator might want to deploy a load-balanced interconnect switch with a subset of the full set of line cards. In addition, line cards might fail and/or be added or removed over the lifetime of the switch. It is therefore desirable to have a load-balanced interconnect switch capable of operating properly with, ideally, any subset of the full set of line cards.

### SUMMARY OF THE INVENTION

According to one embodiment, an interconnect switch has an optical switch fabric (OSF) having N input ports and N output ports. The OSF has a bank of optically interconnected wavelength-selective switches and is adapted to route optical signals from the input ports to the output ports. In a fully deployed implementation, the interconnect switch has N input line cards and N output line cards. Each of the input line cards is adapted to generate N respective modulated optical signals using carrier wavelengths that are controllably selected from more than N carrier wavelengths to provide wavelength redundancy for optically connecting the input line card and any of the output line cards. In a partially deployed implementation, the interconnect switch has fewer than N input line cards and/or fewer than N output line cards. In either the fully deployed implementation or a partially deployed implementation, the interconnect switch is capable of complete or partial load balancing while utilizing the full transmit capacity of the input line cards.

According to another embodiment, an optical interconnect switch has an optical switch fabric (OSF) having N input ports and N output ports, where N is an integer greater than one. The OSF includes: (i) N 1×M wavelength-selective switches (WSSs), where M is an integer greater than one; and (ii) N M×1 WSSs optically coupled to the N 1×M WSSs. Each of the 1×M WSSs has an input port and M output ports, wherein the input ports of the N 1×M WSSs are the N input ports of the OSF. Each of the M×1 WSSs has M input ports and an output port, wherein the output ports of said N 1×M WSSs are the N output ports of the OSF. The OSF is adapted to route optical signals from the input ports to the output ports. The optical interconnect switch further has one or more input line cards, each optically coupled to a corresponding input port of the OSF and adapted to generate up to N respective modulated optical signals based on a respective incoming signal. These up to N modulated optical signals are multiplexed and applied to the corresponding input port of the OSF. The optical interconnect switch also has one or more output line cards, each optically coupled to a corresponding output port of the OSF and adapted to receive a respective optical output signal from that output port. The received optical output signal has one or more spectral components corresponding to the multiplexed optical signals applied to the input ports of the OSF by the one or more input line cards.

According to yet another embodiment, a method for routing signals having the steps of: at each of one or more selected input ports of an optical switch fabric (OSF) having N input ports and N output ports, (i) generating up to N respective modulated optical signals based on a respective incoming signal; (ii) multiplexing the up to N modulated optical signals into a corresponding multiplexed optical signal; and (iii) applying the multiplexed optical signal to the input port. The OSF includes N 1×M wavelength-selective switches (WSSs) and N M×1 WSSs optically coupled to the N 1×M WSSs. Each of the 1×M WSSs has an input port and M output ports, wherein the input ports of the N 1×M WSSs are the N input ports of the OSF. Each of the M×1 WSSs has M input ports and an output port, wherein the output ports of the N 1×M WSSs are the N output ports of the OSF. The OSF is adapted to route optical signals from its input ports to its output ports. The method further has the steps of: (iv) routing the one or more multiplexed optical signals from the corresponding one or more input ports to one or more selected output ports of the OSF; and (v) at each of the one or more selected output ports, receiving a respective optical output signal having one or more modulated optical signals corresponding to the one or more multiplexed optical signals.

### BRIEF DESCRIPTION OF THE DRAWINGS

Other aspects, features, and benefits of the present invention will become more fully apparent from the following detailed description, the appended claims, and the accompanying drawings in which:

FIG. 1 shows a block diagram of a 4×4 scalable load-balanced interconnect switch according to one embodiment of the invention;

FIGS. 2A-C show block diagrams of three different partially deployed implementations of the switch of FIG. 1;

FIG. 3 shows a block diagram of a switch bank that can be used in the switch of FIG. 1 according to one embodiment of the invention;

FIGS. 4A-B show block diagrams of two different partially deployed implementations of the switch of FIG. 1 having the switch bank of FIG. 3;

FIG. 5 shows a block diagram of a wavelength-routed network that can be used in the switch of FIG. 1 according to another embodiment of the invention;

FIGS. 6A-C show block diagrams of three different partially deployed implementations of the switch of FIG. 1 having the wavelength-routed network of FIG. 5;

FIG. 7A shows a block diagram of an input line card that can be used in an N×N scalable load-balanced interconnect switch according to one embodiment of the invention;

FIG. 7B shows a block diagram of an output line card that can be used in an N×N scalable load-balanced interconnect switch according to one embodiment of the invention;

FIG. 8 shows a block diagram of an N×N arrayed waveguide grating that can be used in an N×N scalable load-balanced interconnect switch according to one embodiment of the invention;

FIG. 9 shows a block diagram of an N×N switch bank that can be used in an N×N scalable load-balanced interconnect switch according to one embodiment of the invention;

FIG. 10 shows a block diagram of a 1×N wavelength-selective switch (WSS) that can be used in the switch bank of FIG. 9 according to one embodiment of the invention;

FIG. 11 shows a block diagram of an N×1 WSS that can be used in the switch bank of FIG. 9 according to one embodiment of the invention; and

FIG. 12 shows a block diagram of a wavelength-routed network that can be used in an N×N scalable load-balanced interconnect switch according to one embodiment of the invention.

### DETAILED DESCRIPTION

### Exemplary 4×4 Scalable Load-Balanced Interconnect Switches

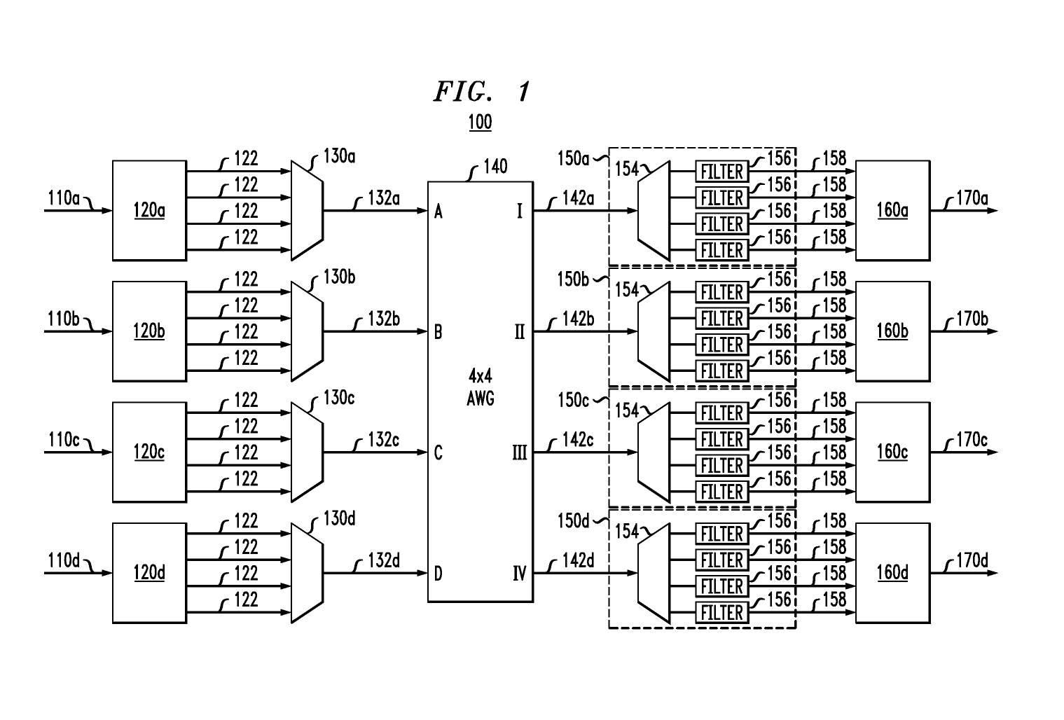

FIG. 1 shows a block diagram of a scalable load-balanced interconnect switch 100 according to one embodiment of the invention. For illustration purposes, switch 100 is shown as having a maximum of four input line cards 120 and a maximum of four output line cards 160. From the description provided herein, one of ordinary skill in the art will be able to make and use a scalable load-balanced interconnect switch analogous to switch 100 but having an arbitrary maximum number of input and output line cards.

Switch 100 is designed to accomplish load balancing using a fixed mesh of waveguide channels of an arrayed waveguide grating (AWG) 140. AWG 140 is a cyclical AWG having four input ports (labeled A-D) and four output ports (labeled I-IV). The cyclical properties of AWG 140 enable it to fully interconnect input ports A-D and output ports I-IV using just four wavelengths (λ₁, λ₂, λ₃, λ₄), e.g., as shown in Table 1.

TABLE 1
Representative Wavelength Grid for AWG 140

Output Port

| | | I | II | III | IV |
|---|---|---|---|---|---|
| Input Port | A | λ₁ | λ₂ | λ₃ | λ₄ |
| | B | λ₄ | λ₁ | λ₂ | λ₃ |
| | C | λ₃ | λ₄ | λ₁ | λ₂ |
| | D | λ₂ | λ₃ | λ₄ | λ₁ |

Wavelengths λ₁, λ₂, λ₃, and λ₄ correspond to the first diffraction order of AWG 140. Alternatively or in addition, AWG 140 can interconnect input ports A-D and output ports I-IV using wavelengths corresponding to a higher diffraction order. For example, AWG 140 can fully interconnect input ports A-D and output ports I-IV using one or more of the following: (i) four wavelengths (λ₅, λ₆, λ₇, λ₈) corresponding to the second diffraction order of the AWG; (ii) four wavelengths (λ₉, λ₁₀, λ₁₁, λ₁₂) corresponding to the third diffraction order of the AWG; (iii) four wavelengths (λ₁₃, λ₁₄, λ₁₅, λ₁₆) corresponding to the fourth diffraction order of the AWG, etc. Modern AWGs are capable of providing about five to ten relatively strong diffraction orders with optical losses that are sufficiently low for transmission of optical signals. A wavelength grid for a higher diffraction order of AWG 140 can be derived from Table 1 by appropriately incrementing the wavelength indices. More specifically, the wavelength grid for the second order of AWG 140 is obtained by incrementing the wavelength indices by four; the wavelength grid for the third order is obtained by incrementing the wavelength indices by eight, etc.

The multiple diffraction orders of AWG 140 provide wavelength redundancy in the interconnection of input and output ports. For example, input port A can be connected to output port I using any wavelength selected from λ₁, λ₅, λ₉, and λ₁₃. Input port A can be connected to output port II using any wavelength selected from λ₂, λ₆, λ₁₀, and λ₁₄, etc. As explained in more detail below, switch 100 utilizes this wavelength redundancy to enable scalable load balancing.

In FIG. 1, switch 100 is shown fully deployed and having four input line cards 120a-d and four output line cards 160a-d. Each input line card 120 connects switch 100 to a respective input line 110. Each output line card 160 connects switch 100 to a respective output line 170.

Line card 120 is adapted to receive an electrical signal from input line 110 and, based on that signal, generate up to four optical output signals 122, thereby serving as an electrical-to-optical (E/O) converter. In a representative implementation, line card 120 has four tunable lasers (not explicitly shown), each capable of generating a respective selected subset of carrier wavelengths λ₁, λ₂, . . . , λ₁₆ or, alternatively, each of those wavelengths, one at a time. Thus, line card 120 is capable of generating up to four different wavelengths at the same time. Each laser is coupled to a respective modulator (not explicitly shown) that modulates the optical carrier generated by the laser using a respective portion of the electrical signal received via input line 110. In a representative configuration, such portion can be composed of a (not necessarily contiguous) set of data units, e.g., frames or packets. Four modulated optical signals 122 generated by the modulators in line card 120 are applied to a corresponding optical signal combiner (e.g., power combiner) 130. Combiner 130 combines those signals into a corresponding wavelength-multiplexed signal 132 and applies that signal to a corresponding input port of AWG 140. Depending on the intended destination (e.g., one of output lines 170a-d) for each particular set of data units, line card 120 uses that set of data units to modulate the appropriate carrier wavelength corresponding to that destination. Line card 120 is configured to appropriately control concurrently generated wavelengths to avoid optical-signal collisions at the corresponding input port of AWG 140.

Each of signals 142a-d that emerge from the output ports of AWG 140 is applied to a respective wavelength demultiplexer (DEMUX) 150. In FIG. 1, each DEMUX 150 is illustratively shown as having a four-way power splitter 154 coupled to a bank of four tunable optical filters 156. Each filter 156 is an optical bandpass filter that can be tuned to transmit a relatively narrow spectral band around a selected one of carrier wavelengths λ₁, λ₂, . . . , λ₁₆ while rejecting the wavelengths outside of that spectral band. In a representative configuration, different optical filters 156 in a particular DEMUX 150 are tuned to different wavelengths corresponding to the spectral composition of the corresponding signal 142. As a result, each of four optical signals 158 produced by DEMUX 150 contains an individual wavelength component of signal 142.

Four optical signals 158 produced by each DEMUX 150 are applied to the corresponding line card 160. Line card 160 converts optical signals 158 into the corresponding electrical signals, thereby serving as an optical-to-electrical (O/E) converter. Line card 160 combines the resulting electrical signals into a time-division multiplexed electrical output signal and applies that signal to the corresponding output line 170. In a representative configuration, line card 160 buffers the data units delivered by optical signals 158 and assembles them, e.g., into an appropriately ordered data-unit sequence, which is then applied to output line 170.

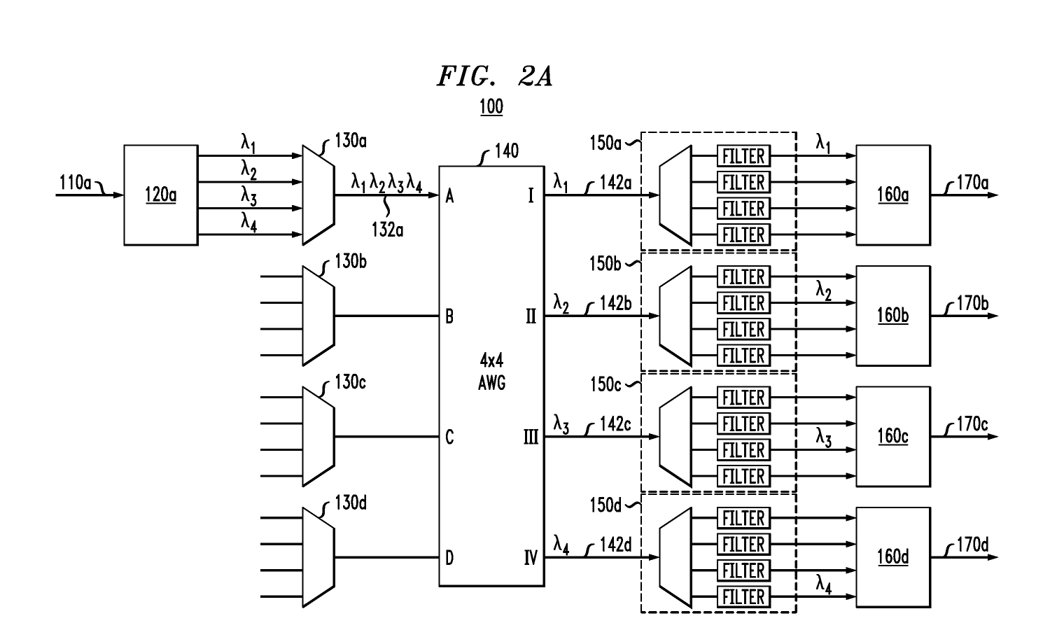

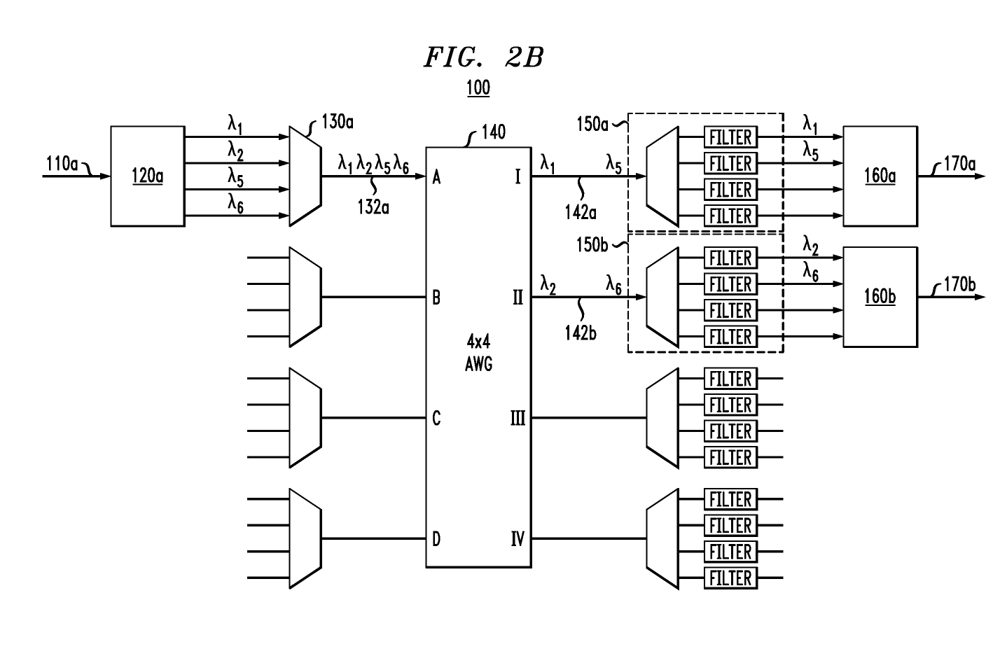

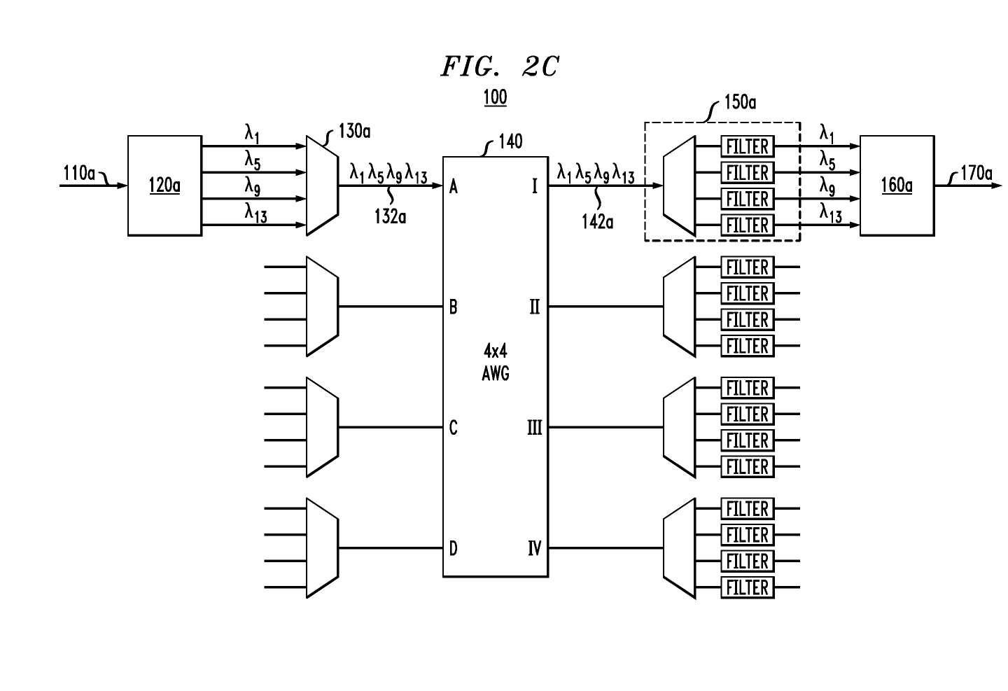

FIGS. 2A-C show block diagrams of three representative partially deployed implementations of switch 100. In each of those implementations, switch 100 is capable of load balancing, e.g., by utilizing the above-described wavelength redundancy of AWG 140. Each of these partially deployed implementations of switch 100 is described in more detail below.

FIG. 2A shows a partially deployed implementation of switch 100, in which the switch has one input line card 120a and four output line cards 160a-d. The four lasers of line card 120a are tuned to wavelengths λ₁, λ₂, λ₃, and λ₄, respectively. The resulting wavelength-multiplexed signal 132a is applied to input port A of AWG 140, which routes the components of that signal according to the wavelength grid of Table 1. Consequently, the signal components corresponding to wavelengths λ₁, λ₂, λ₃, and λ₄ emerge at output ports I, II, III, and IV, respectively. Four filters 156 in DEMUX 150a are tuned so that one of those filters transmits the signal component corresponding to wavelength λ₁ while the remaining three filters block that component. Four filters 156 in DEMUX 150b are tuned so that one of those filters transmits the signal component corresponding to wavelength λ₂ while the remaining three filters block that component. Four filters 156 in DEMUX 150c are tuned so that one of those filters transmits the signal component corresponding to wavelength λ₃ while the remaining three filters block that component. Four filters 156 in DEMUX 150d are tuned so that one of those filters transmits the signal component corresponding to wavelength λ₄ while the remaining three filters block that component. Assuming that input line card 120a evenly distributes the incoming data units amongst the four wavelengths, each of output line cards 160a-d will receive one quarter of the traffic, hence the load balancing.

One skilled in the art will appreciate that one or more additional input line cards 120 can be added to the implementation of switch 100 shown in FIG. 2A, with each of those additional input line cards configured similar to input line card 120a. The carrier wavelengths used by an additional card can correspond to the first order or a selected higher order of AWG 140. For each added input line card 120, an additional one of the blocking filters 156 in each DEMUX 150 is configured to transmit a respective additional spectral component of the corresponding wavelength-multiplexed signal 142.

For example, if input line card 120b is added to the implementation of switch 100 shown in FIG. 2A and that line card is configured to use wavelengths λ₁, λ₂, λ₃, and λ₄, then (i) wavelength-multiplexed signal 142a has spectral components corresponding to wavelengths λ₁ and λ₄; (ii) wavelength-multiplexed signal 142b has spectral components corresponding to wavelengths λ₁ and λ₂; (iii) wavelength-multiplexed signal 142c has spectral components corresponding to wavelengths λ₂ and λ₃; and (iv) wavelength-multiplexed signal 142d has spectral components corresponding to wavelengths λ₃ and λ₄. Accordingly, four of the (previously) blocking filters, one in each of DEMUXes 150a-d, is tuned to transmit spectral bands corresponding to wavelengths λ₄, λ₁, λ₂, and λ₃, respectively. Assuming that, similar to input line card 120a, input line card 120b evenly distributes the incoming data units amongst its four wavelengths, each of output line cards 160a-d will still receive one quarter of the total traffic. For each output line card 160, one half of its traffic will originate from input line card 120a and the other half from input line card 120b.

FIG. 2B shows a partially deployed implementation of switch 100, in which the switch has one input line card 120a and two output line cards 160a-b. The four lasers of line card 120a are tuned to wavelengths λ₁, λ₂, λ₅, and λ₆, respectively. The resulting wavelength-multiplexed signal 132a is applied to input port A of AWG 140, which routes the components of that signal according to the wavelength grids of Table 1 and the analogous table corresponding to the second order of AWG 140. Consequently, the signal components corresponding to wavelengths λ₁ and λ₅ emerge at output port I, and the signal components corresponding to wavelengths λ₂ and λ₆ emerge at output port II. Two filters 156 in DEMUX 150a are tuned so that those filters transmit the signal components corresponding to wavelengths II and λ₅, respectively, while the remaining two filters block those components. Two filters 156 in DEMUX 150b are tuned so that those filters transmit the signal components corresponding to wavelengths λ₂ and λ₆, respectively, while the remaining two filters block those components. Assuming that input line card 120a evenly distributes the incoming data units amongst the four wavelengths, each of output line cards 160a-b will receive one half of the traffic, hence the load balancing.

One skilled in the art will appreciate that an additional input line card 120 can be added to the implementation of switch 100 shown in FIG. 2B. For example, if input line card 120b is added and configured to use wavelengths λ₁, λ₄, λ₅, and λ₈, then (i) wavelength-multiplexed signal 142a has spectral components corresponding to wavelengths λ₁, λ₄, λ₅, and λ₈ and (ii) wavelength-multiplexed signal 142b has spectral components corresponding to wavelengths λ₁, λ₂, λ₅, and λ₆. Accordingly, two of the blocking filters in DEMUX 150a are tuned to transmit spectral bands corresponding to wavelengths λ₄ and λ₈, respectively. Similarly, two of the blocking filters in DEMUX 150b are tuned to transmit spectral bands corresponding to wavelengths λ₁ and λ₅, respectively. Assuming that, similar to input line card 120a, input line card 120b evenly distributes the incoming data units amongst its four wavelengths, each of output line cards 160a-b will receive one half of the total traffic. For each of output line cards 160a-b, one half of its traffic will originate from input line card 120a and the other half from input line card 120b.

FIG. 2C shows a partially deployed implementation of switch 100, in which the switch has one input line card 120a and one output line card 160a. The four lasers of line card 120a are tuned to wavelengths λ₁, λ₅, λ₉, and λ₁₃, respectively. The resulting wavelength-multiplexed signal 132a is applied to input port A of AWG 140, which routes the components of that signal according to the wavelength grids of Table 1 and the analogous tables corresponding to the second, third, and fourth orders of the AWG. As a result, all signal components of signal 132a emerge at output port I. Four filters 156 in DEMUX 150a are tuned to transmit the signal components corresponding to wavelengths λ₁, λ₅, λ₉, and λ₁₃, respectively. Assuming that input line card 120a evenly distributes the incoming data units amongst the four wavelengths, all of those units will be received by output line card 160a, thereby enabling both line cards to operate at full capacity.

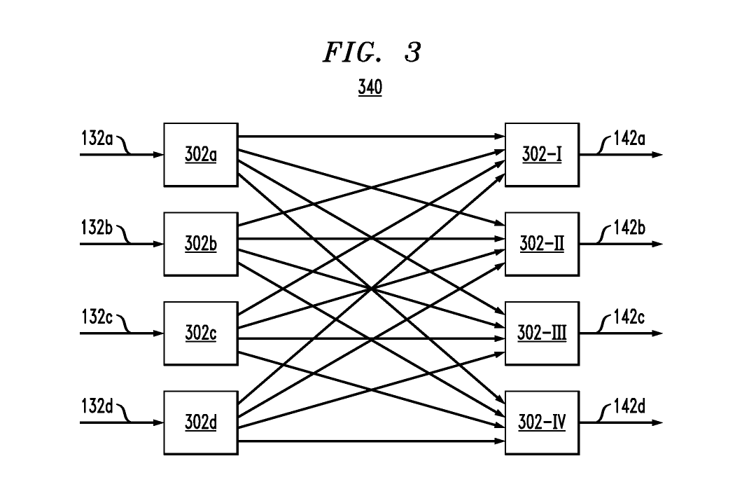

FIG. 3 shows a block diagram of a switch bank 340 that can be used in place of AWG 140 in switch 100 according to one embodiment of the invention. Bank 340 has four 1×4 wavelength-selective switches (WSSs) 302a-d and four 4×1 WSSs 302-(I-IV) interconnected as shown in the figure. A WSS is an optical switch that can direct any combination of spectral components selected from the spectral components received at its input port(s) to any of its output ports. Each of WSSs 302a-d and 302-(I-IV) is a separate instance of the same physical device having (i) four ports at its first side and (ii) one port at its second side. To implement any of WSSs 302-(I-IV), the device is configured so that the four ports at the first side serve as input ports and the single port at the second side serves as an output port. To implement any of WSSs 302a-d, the device is configured so that the single port at the second side serves as an input port and the four ports at the first side serve as output ports. In one embodiment, WSS 302 can be implemented using an add-drop filter disclosed by C. R. Doerr, et al., in “Eight-Wavelength Add-Drop Filter with True Reconfigurability,” IEEE Photonics Technology Letters, 2003, v. 15, pp. 138-140, which is incorporated herein by reference in its entirety. In another embodiment, any of WSSs 302a-d can be replaced by a power splitter. Alternatively, any of WSSs 302-(I-IV) can be replaced by a power combiner.

If all line cards 120 and 160 are present and operable and each of input line cards 120 is configured to generate wavelengths λ₁, λ₂, λ₃, and λ₄, then WSSs 302 in block 340 can be configured to route optical signals to emulate the wavelength grid of Table 1. More specifically, WSS 302a is configured to direct signals corresponding to wavelengths λ₁, λ₂, λ₃, and λ₄ toward WSSs 302-I, 302-II, 302-III, and 302-IV, respectively. WSS 302b is configured to direct signals corresponding to wavelengths λ₄, λ₁, λ₂, and λ₃ toward WSSs 302-I, 302-II, 302-III, and 302-IV, respectively. WSS 302c is configured to direct signals corresponding to wavelengths λ₃, λ₄, λ₁, and λ₂ toward WSSs 302-I, 302-II, 302-III, and 302-IV, respectively. WSS 302d is configured to direct signals corresponding to wavelengths λ₂, λ₃, λ₄, and λ₁ toward WSSs 302-I, 302-II, 302-III, and 302-IV, respectively. Each of WSSs 302-I, 302-II, 302-III, and 302-IV is configured to direct each of the received signals to the output port. In this configuration, each of output line cards 160a-d will receive one quarter of the total traffic. For each particular output line card 160, different quarters of its traffic will originate from different input line cards 120a-d.

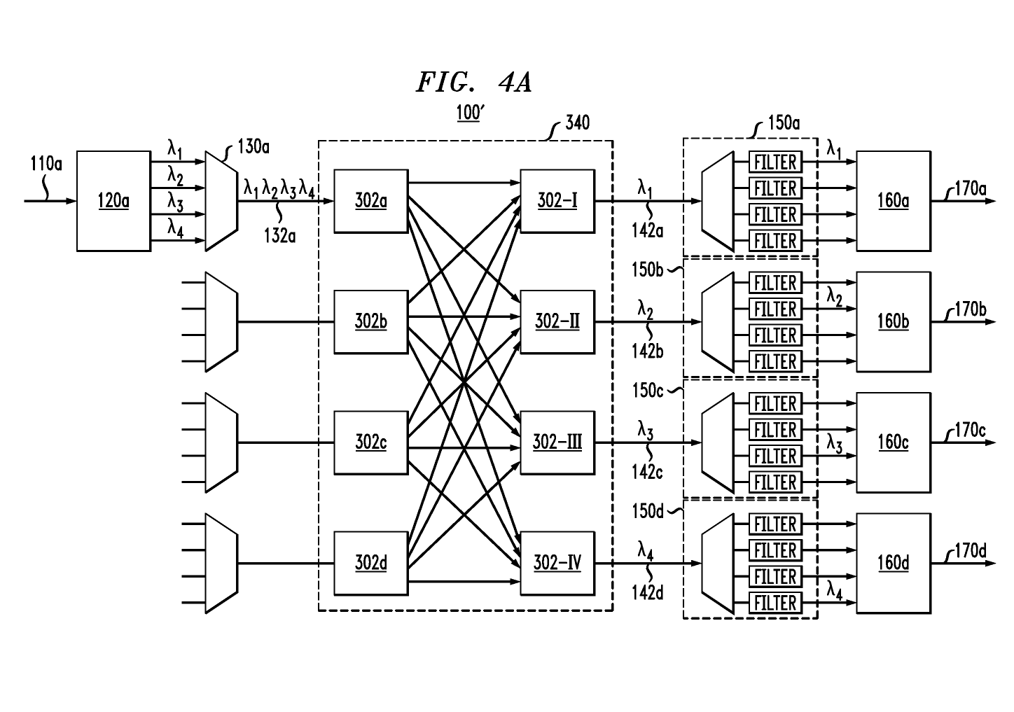

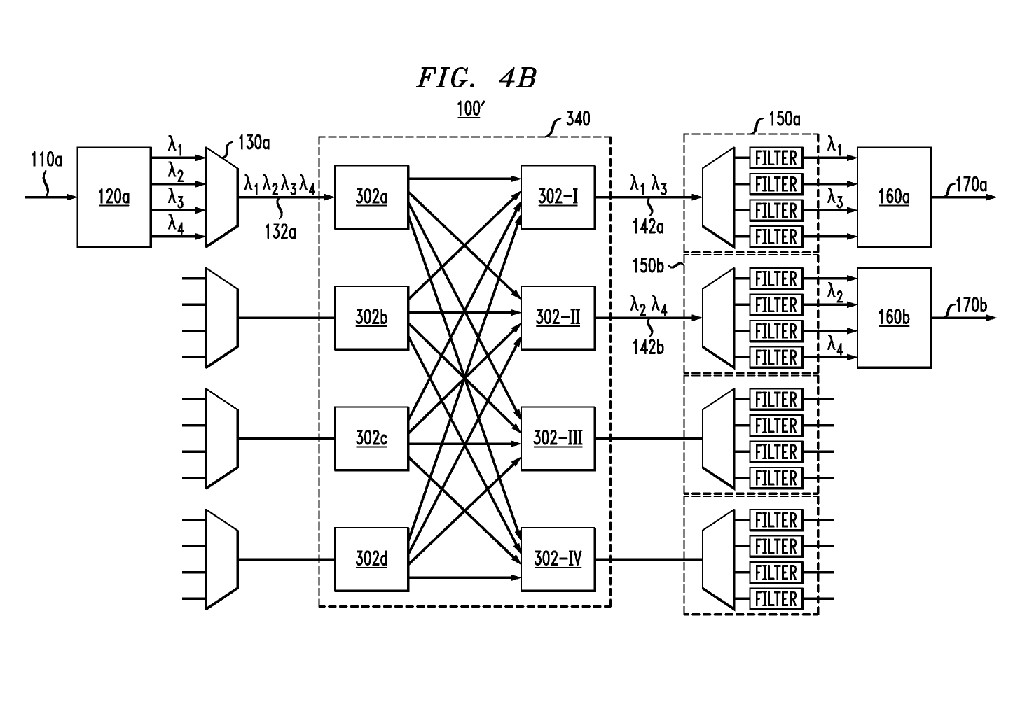

FIGS. 4A-B show block diagrams of two representative partially deployed implementations of switch 100′. Switch 100′ is generally similar to switch 100, except that it utilizes switch bank 340 in place of AWG 140. Using the above-mentioned properties of WSSs 302, switch 100′ is capable of load balancing with fewer wavelengths than switch 100.

FIG. 4A shows a partially deployed implementation of switch 100′, in which the switch has one input line card 120a and four output line cards 160a-d. The four lasers of line card 120a are tuned to wavelengths λ₁, λ₂, λ₃, and λ₄, respectively. The resulting wavelength-multiplexed signal 132a is applied to WSS 302a. WSS 302a routes signal 132a so that the signal components corresponding to wavelengths λ₁, λ₂, λ₃, and λ₄ are directed to WSSs 302-I, 302-II, 302-III, and 302-IV, respectively. Four filters 156 in DEMUX 150a are tuned so that one of those filters transmits the signal component corresponding to wavelength λ₁ while the remaining three filters block that component. Four filters 156 in DEMUX 150b are tuned so that one of those filters transmits the signal component corresponding to wavelength λ₂ while the remaining three filters block that component. Four filters 156 in DEMUX 150c are tuned so that one of those filters transmits the signal component corresponding to wavelength λ₃ while the remaining three filters block that component. Four filters 156 in DEMUX 150d are tuned so that one of those filters transmits the signal component corresponding to wavelength λ₄ while the remaining three filters block that component. Assuming that input line card 120a evenly distributes the incoming data units amongst the four wavelengths, each of output line cards 160a-d will receive one quarter of the traffic, hence the load balancing.

One skilled in the art will appreciate that one or more additional input line cards 120 can be added to the implementation of switch 100′ shown in FIG. 4A, with each of those additional input line cards configured similar to input line card 120a. For each added input line card 120, an additional one of the (previously) blocking filters 156 in each DEMUX 150 is configured to transmit a respective additional spectral component of the corresponding wavelength-multiplexed signal 142.

For example, if input line card 120b is added to the implementation of switch 100′ shown in FIG. 4A and that line card is configured to use wavelengths λ₁, λ₂, λ₃, and λ₄, then WSS 302b is configured to route signal 132b so that the signal components corresponding to wavelengths λ₄, λ₁, λ₂, and λ₃ are directed to WSSs 302-I, 302-II, 302-III, and 302-IV, respectively. As a result, (i) wavelength-multiplexed signal 142a has spectral components corresponding to wavelengths λ₁ and λ₄; (ii) wavelength-multiplexed signal 142b has spectral components corresponding to wavelengths λ₁ and λ₂; (iii) wavelength-multiplexed signal 142c has spectral components corresponding to wavelengths λ₂ and λ₃; and (iv) wavelength-multiplexed signal 142d has spectral components corresponding to wavelengths λ₃ and λ₄. Accordingly, four of the blocking filters, one in each of DEMUXes 150a-d, is tuned to transmit spectral bands corresponding to wavelengths λ₄, λ₁, λ₂, and λ₃, respectively. Assuming that, similar to input line card 120a, input line card 120b evenly distributes the incoming data units amongst its four wavelengths, each of output line cards 160a-d will receive one quarter of the total traffic. For each output line card 160, one half of its traffic will originate from input line card 120a and the other half from input line card 120b.

FIG. 4B shows a partially deployed implementation of switch 100′, in which the switch has one input line card 120a and two output line cards 160a-b. The four lasers of line card 120a are tuned to wavelengths λ₁, λ₂, λ₃, and λ₄, respectively. The resulting wavelength-multiplexed signal 132a is applied to WSS 302a. WSS 302a routes signal 132a so that the signal components pairs corresponding to wavelengths (λ₁, λ₃) and (λ₂, λ₄) are directed to WSSs 302-I and 302-II, respectively. As a result, wavelength-multiplexed signal 142a has the spectral components corresponding to wavelengths λ₁ and λ₃, and wavelength-multiplexed signal 142b has the spectral components corresponding to wavelengths λ₂ and λ₄. Two filters 156 in DEMUX 150a are tuned so that those filters transmit the spectral components corresponding to wavelengths λ₁ and λ₃, respectively, while the remaining two filters block those components. Two filters 156 in DEMUX 150b are tuned so that those filters transmit the spectral components corresponding to wavelengths λ₂ and λ₄, respectively, while the remaining two filters block those components. Assuming that input line card 120a evenly distributes the incoming data units amongst the four wavelengths, each of output line cards 160a-b will receive one half of the traffic, hence the load balancing.

One skilled in the art will appreciate that an additional input line card 120 can be added to the implementation of switch 100′ shown in FIG. 4B. For example, if input line card 120b is added and configured to use wavelengths λ₁, λ₂, λ₃, and λ₄, then WSS 302b is configured to route signal 132b so that the signal-component pairs corresponding to wavelengths (λ₁, λ₃) and (λ₂, λ₄) are directed to WSSs 302-II and 302-I, respectively. As a result, wavelength-multiplexed signal 142a has (i) signal components corresponding to wavelengths λ₁ and λ₃ that originated from input line card 120a and (ii) signal components corresponding to wavelengths λ₂ and λ₄ that originated from input line card 120b. Similarly, wavelength-multiplexed signal 142b has (i) signal components corresponding to wavelengths λ₁ and λ₃ that originated from input line card 120b and (ii) signal components corresponding to wavelengths λ₂ and λ₄ that originated from input line card 120a. Two of the blocking filters in DEMUX 150a are tuned to transmit spectral bands corresponding to wavelengths λ₂ and λ₄, respectively. Similarly, two of the blocking filters in DEMUX 150b are tuned to transmit spectral bands corresponding to wavelengths λ₁ and λ₃, respectively. Assuming that, similar to input line card 120a, input line card 120b evenly distributes the incoming data units amongst its four wavelengths, each of output line cards 160a-b will receive one half of the total traffic. For each of output line cards 160a-b, one half of its traffic will originate from input line card 120a and the other half from input line card 120b.

One skilled in the art will further appreciate that one of output line cards 160a-b can be removed from the implementation of switch 100′ shown in FIG. 4B. For example, if output line card 160b is removed, then WSS 302a is reconfigured to direct all spectral components of signal 132a to WSS 302-I. Two of the blocking filters in DEMUX 150a are then tuned to transmit spectral bands corresponding to wavelengths λ₂ and λ₄, respectively. As a result, output line card 160a will receive all traffic from input line card 120a.

FIG. 5 shows a block diagram of a wavelength-routed network 540 that can be used in place of AWG 140 in switch 100 according to another embodiment of the invention. Network 540 is constructed of (i) four 1×2 WSSs 502a-d, (ii) two AWGs 140a-b, and (iii) four 2×1 WSSs 502-(I-IV), all interconnected as shown in the figure. Similar to WSSs 302a-d and 302-(I-IV) of FIG. 3, each of WSSs 502a-d and 502-(I-IV) represents an instance of the same physical device. The device has two ports at its first side and one port at its second side. To implement any of WSSs 502-(I-IV), the device is configured so that the two ports at the first side serve as input ports and the single port at the second side serves as an output port. To implement any of WSSs 502a-d, the device is configured so that the single port at the second side serves as an input port and the two ports at the first side serve as output ports.

While network 540 appears more complex than, e.g., a single AWG 140, the use of the network in lieu of the AWG might provide some benefits. One such benefit is that network 540 enables load balancing with fewer wavelengths than AWG 140 alone. In addition, if scaled up for use in a switch having a larger maximum number (e.g., 64) of line cards, the architecture of network 540 enables the corresponding switch to be operational with a smaller minimum number of line cards than that in a comparable switch utilizing (i) a single AWG analogous to AWG 140 or (ii) a switch bank analogous to switch bank 340.

If all line cards 120 and 160 are present and operable and each of input line cards 120 is configured to generate wavelengths λ₁, λ₂, λ₃, and λ₄, then network 540 is configured so that each of WSSs 502a-d directs all four signal components of the corresponding wavelength-multiplexed signal 132 to AWG 140a and none to AWG 140b. AWG 140a routes the received signal components in accordance with the wavelength grid of Table 1. Each of WSSs 502-(I-IV) is configured to pass through the respective wavelength-multiplexed signal received from AWG 140a. In this configuration, network 540 functions similar to AWG 140 in FIG. 1 because each of the WSSs is configured to select AWG 140a, thereby causing AWG 140b to be excluded from the traffic. For the reasons explained above in reference to FIG. 1, each of output line cards 160a-d will receive one quarter of the total traffic. For each particular output line card 160, different quarters of its traffic will originate from different input line cards 120a-d.

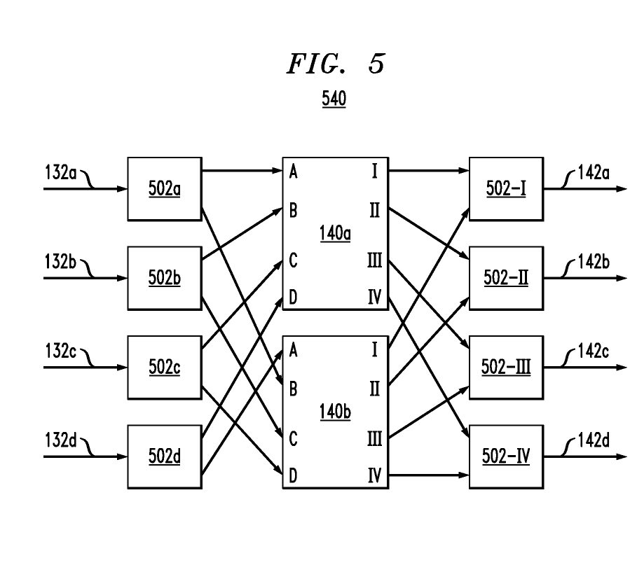

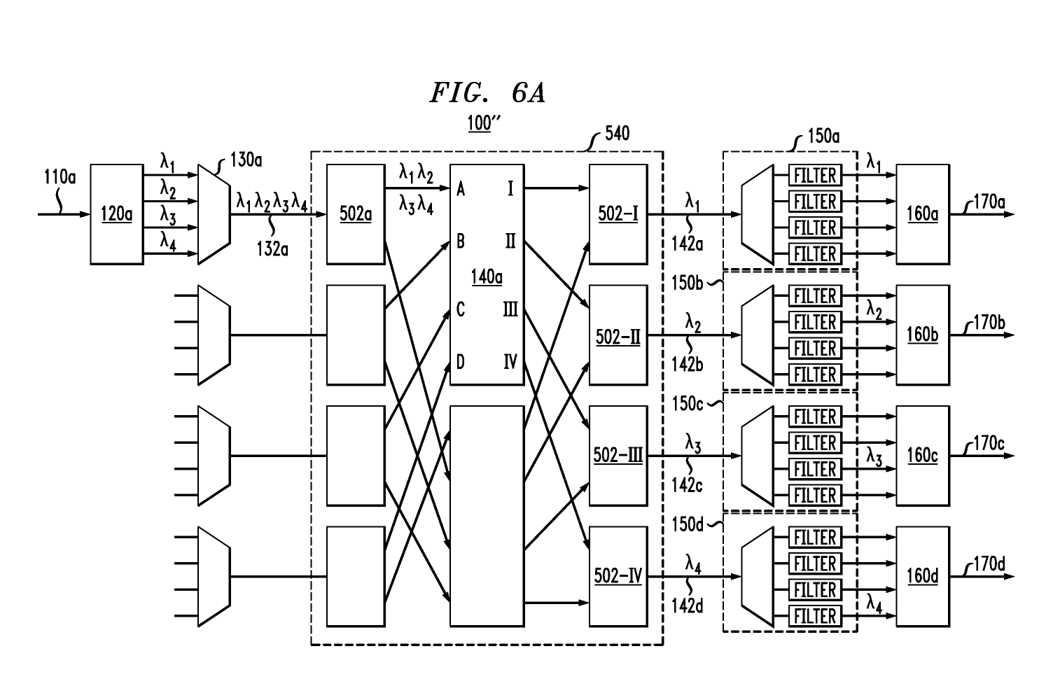

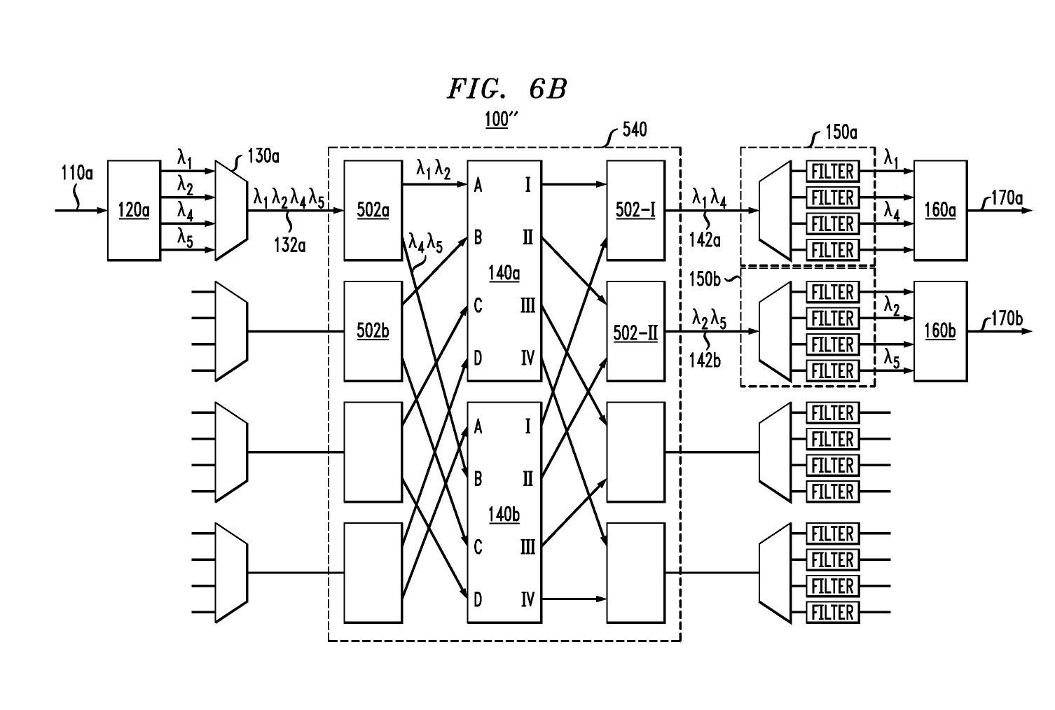

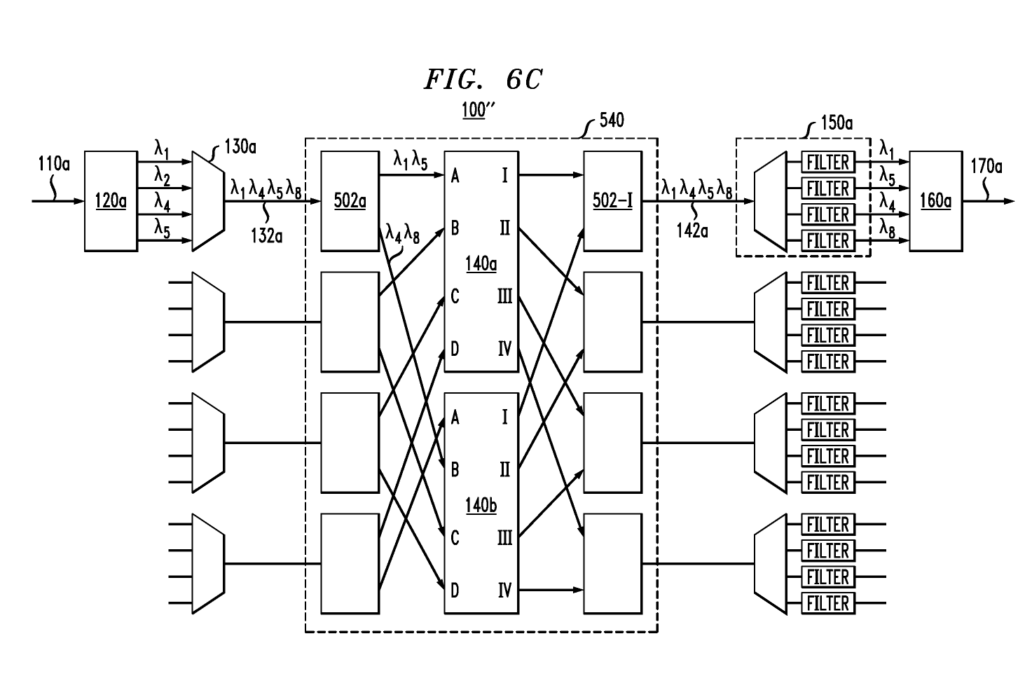

FIGS. 6A-C show block diagrams of three representative partially deployed implementations of switch 100″. Switch 100″ is generally similar to switch 100, except that it utilizes network 540 in place of AWG 140. Using the properties of network 540, switch 100″ is capable of providing load balancing with fewer wavelengths than switch 100.

FIG. 6A shows a partially deployed implementation of switch 100″, in which the switch has one input line card 120a and four output line cards 160a-d. The four lasers of line card 120a are tuned to wavelengths λ₁, λ₂, λ₃, and λ₄, respectively. The resulting wavelength-multiplexed signal 132a is applied to WSS 502a, which is configured to direct all four spectral components of the wavelength-multiplexed signal to input port A of AWG 140a. AWG 140a routes the received signal components in accordance with the wavelength grid of Table 1. As a result, the signal components corresponding to wavelengths λ₁, λ₂, λ₃, and λ₄ emerge at output ports I, II, III, and IV, respectively. Each of WSSs 502-(I-IV) is configured to pass through the respective signal received from AWG 140a. Four filters 156 in DEMUX 150a are tuned so that one of those filters transmits the signal component corresponding to wavelength λ₁ while the remaining three filters block that component. Four filters 156 in DEMUX 150b are tuned so that one of those filters transmits the signal component corresponding to wavelength λ₂ while the remaining three filters block that component. Four filters 156 in DEMUX 150c are tuned so that one of those filters transmits the signal component corresponding to wavelength λ₃ while the remaining three filters block that component. Four filters 156 in DEMUX 150d are tuned so that one of those filters transmits the signal component corresponding to wavelength λ₄ while the remaining three filters block that component. Assuming that input line card 120a evenly distributes the incoming data units amongst the four wavelengths, each of output line cards 160a-d will receive one quarter of the traffic, hence the load balancing.

One skilled in the art will appreciate that one or more additional input line cards 120 can be added to the implementation of switch 100″ shown in FIG. 6A, with each of those additional input line cards configured similar to input line card 120a and the corresponding one or more of WSSs 502b-d configured to direct all spectral components of the corresponding one or more wavelength-multiplexed signals 132 to AWG 140a. For each added input line card 120, an additional one of the blocking filters 156 in each DEMUX 150 is configured to transmit a respective additional spectral component of the corresponding wavelength-multiplexed signal 142.

For example, if input line card 120b is added to the implementation of switch 100″ shown in FIG. 6A, then (i) wavelength-multiplexed signal 142a has spectral components corresponding to wavelengths λ₁ and λ₄; (ii) wavelength-multiplexed signal 142b has spectral components corresponding to wavelengths λ₁ and λ₂; (iii) wavelength-multiplexed signal 142c has spectral components corresponding to wavelengths λ₂ and λ₃; and (iv) wavelength-multiplexed signal 142d has spectral components corresponding to wavelengths λ₃ and λ₄. Accordingly, four of the blocking filters, one in each of DEMUXes 150a-d, is tuned to transmit spectral bands corresponding to wavelengths λ₄, λ₁, λ₂, and λ₃, respectively. Assuming that, similar to input line card 120a, input line card 120b evenly distributes the incoming data units amongst its four wavelengths, each of output line cards 160a-d will receive one quarter of the total traffic. For each output line card 160, one half of its traffic will originate from input line card 120a and the other half from input line card 120b.

FIG. 6B shows a partially deployed implementation of switch 100″, in which the switch has one input line card 120a and two output line cards 160a-b. The four lasers of line card 120a are tuned to wavelengths λ₁, λ₂, λ₄, and λ₅, respectively. The resulting wavelength-multiplexed signal 132a is applied to WSS 502a. WSS 502a routes signal 132a so that the signal-component pairs corresponding to wavelengths (λ₁, λ₂) and (λ₄, λ₅) are directed to AWGs 140a and 140b, respectively. AWGs 140a-b route the received signal components according to the wavelength grids of Table 1 and the analogous table corresponding to the second order of the AWG. As a result, wavelength-multiplexed signal 142a has the signal components corresponding to wavelengths λ₁ and λ₄, and wavelength-multiplexed signal 142b has the signal components corresponding to wavelengths λ₂ and λ₅. Two filters 156 in DEMUX 150a are tuned so that those filters transmit the signal components corresponding to wavelengths λ₁ and λ₄, respectively, while the remaining two filters block those components. Two filters 156 in DEMUX 150b are tuned so that those filters transmit the signal components corresponding to wavelengths λ₂ and λ₅, respectively, while the remaining two filters block those components. Assuming that input line card 120a evenly distributes the incoming data units amongst the four wavelengths, each of output line cards 160a-b will receive one half of the traffic, hence the load balancing.

One skilled in the art will appreciate that an additional input line card 120 can be added to the implementation of switch 100″ shown in FIG. 6B. For example, if input line card 120b is added and configured to use wavelengths λ₁, λ₃, λ₄, and λ₈, then WSS 502b is configured to route signal 132b so that the signal-component pairs corresponding to wavelengths (λ₁, λ₈) and (λ₃, λ₄) are directed to AWGs 140a and 140b, respectively. AWGs 140a-b route the received signal components according to the wavelength grids of Table 1 and the analogous table corresponding to the second order of the AWG. As a result, wavelength-multiplexed signal 142a has (i) signal components corresponding to wavelengths λ₁ and λ₄ that originated from input line card 120a and (ii) signal components corresponding to wavelengths λ₃ and λ₈ that originated from input line card 120b. Similarly, wavelength-multiplexed signal 142b has (i) signal components corresponding to wavelengths λ₂ and λ₅ that originated from input line card 120a and (ii) signal components corresponding to wavelengths λ₁ and λ₄ that originated from input line card 120b. Two of the blocking filters in DEMUX 150a are tuned to transmit spectral bands corresponding to wavelengths λ₃ and λ₈, respectively. Similarly, two of the blocking filters in DEMUX 150b are tuned to transmit spectral bands corresponding to wavelengths λ₁ and λ₄, respectively. Assuming that, similar to input line card 120a, input line card 120b evenly distributes the incoming data units amongst its four wavelengths, each of output line cards 160a-b will receive one half of the total traffic. For each of output line cards 160a-b, one half of its traffic will originate from input line card 120a and the other half from input line card 120b.

FIG. 6C shows a partially deployed implementation of switch 100″, in which the switch has one input line card 120a and one output line card 160a. The four lasers of line card 120a are tuned to wavelengths λ₁, λ₄, λ₅, and λ₈, respectively. The resulting wavelength-multiplexed signal 132a is applied to WSS 502a. WSS 502a routes signal 132a so that the signal-component pairs corresponding to wavelengths (λ₁, λ₅) and (λ₄, λ₈) are directed to AWGs 140a and 140b, respectively. AWGs 140a-b route the received signal components according to the wavelength grids of Table 1 and the analogous table corresponding to the second order of the AWG. As a result, all signal components of signal 132a are directed to WSS 502-I, which further directs them to DEMUX 150a. Four filters 156 in DEMUX 150a are tuned to transmit the spectral components corresponding to wavelengths λ₁, λ₄, λ₅, and λ₈, respectively. Assuming that input line card 120a evenly distributes the incoming data units amongst the four wavelengths, all of those units will be received by output line card 160a to enable both line cards to operate at full capacity.

### N×N Scalable Load-Balanced Interconnect Switches

This section describes optical components for implementing an N×N scalable load-balanced interconnect switch. Such a switch can be constructed from these components using any one of the switch architectures described above in reference to FIGS. 1-6. Theoretically, N can be any integer greater than one. Practically, the maximum achievable N might be limited by one or more of the following: (1) the spectral tunability range of the lasers employed in an input line card analogous to input line card 120, (2) the maximum number of relatively strong diffraction orders in an N×N AWG analogous to AWG 140, (3) the maximum technologically achievable size of the AWG, and (4) the maximum technologically achievable size of a 1×N (or N×1) WSS analogous to WSS 302 or 502.

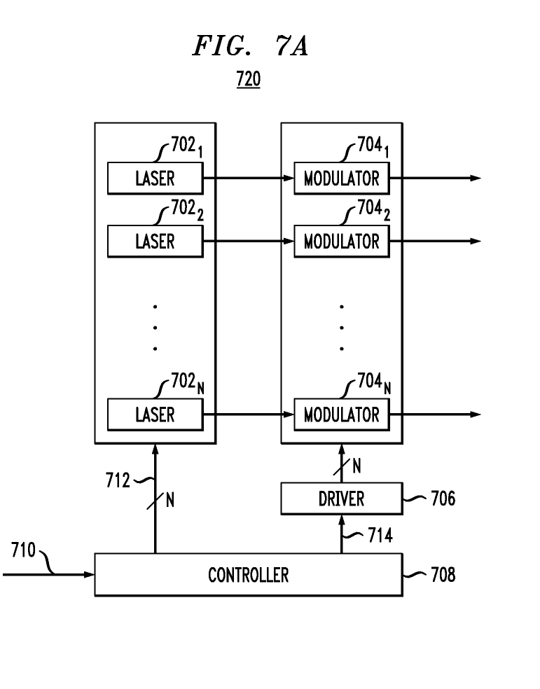

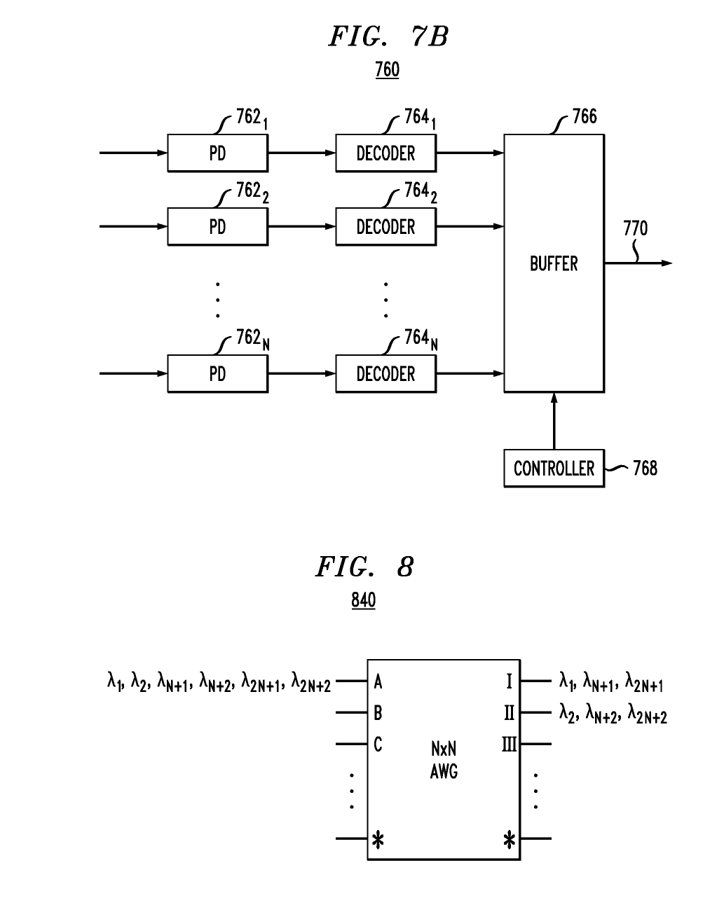

FIG. 7A shows a block diagram of an input line card 720 that can be used in an N×N scalable load-balanced interconnect switch according to one embodiment of the invention. Line card 720 is generally analogous to line card 120 of switch 100. Line card 720 has N tunable lasers 702 that feed N respective optical modulators 704. A controller 708 controls, via a control signal 712, the wavelength generated by each individual laser 702. Controller 708 further controls, via a control signal 714, a driver circuit 706 that drives each individual modulator 704. An input signal 710 received byline card 720 and applied to controller 708 delivers the data that modulators 704 modulate onto the optical carriers generated by lasers 702.

FIG. 7B shows a block diagram of an output line card 760 that can be used in an N×N scalable load-balanced switch according to one embodiment of the invention. Line card 760 is generally analogous to line card 160 of switch 100. Line card 760 has N photo-detectors (PDs) 762, each coupled to a respective signal decoder 764. Each decoder 764 stores the decoded data in a buffer 766. A controller 768 controls the order in which the stored data are output from buffer 766 via an output signal 770.

FIG. 8 shows a block diagram of an N×N AWG 840 that can be used in an N×N scalable load-balanced interconnect switch according to one embodiment of the invention. AWG 840 is a cyclical AWG that is generally analogous to AWG 140 of switch 100. As such, AWG 840 is characterized by a wavelength grid that is analogous to that of Table 1. For example, FIG. 8 illustrates the routing of six representative optical signals corresponding to three different diffraction orders of AWG 840. More specifically, the optical signals having carrier wavelengths λ₁, λ_{N+1}, and λ_{2N+1} correspond to the first, second, and third diffraction orders of AWG 840, respectively, and are routed by the AWG from input port A to output port I. The optical signals having carrier wavelengths λ₂, λ_{N+2}, and λ_{2N+2} also correspond to the first, second, and third diffraction orders of AWG 840, respectively, and are routed by the AWG from input port A to output port II. One skilled in the art will appreciate that the wavelength grid uniquely determines the routing path(s) for each optical signal applied to an input port of AWG 840.

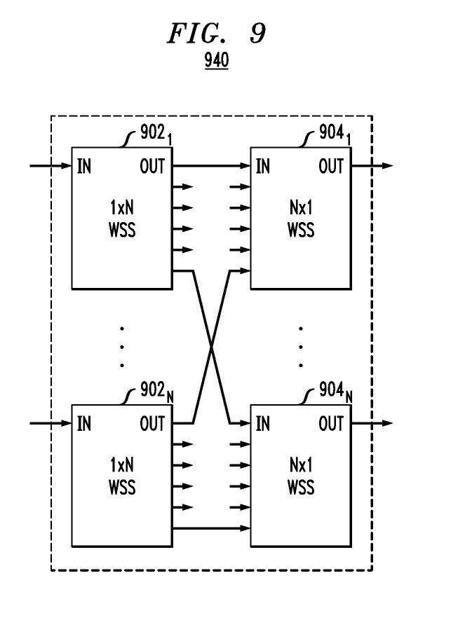

FIG. 9 shows a block diagram of an N×N switch bank 940 that can be used in an N×N scalable load-balanced switch according to one embodiment of the invention. Bank 940 is analogous to bank 340 (FIG. 3) and has N 1×N wavelength selective switches (WSSs) 902₁-902_{N} and N N×1 WSSs 904₁-904_{N}. WSSs 902 and 904 are interconnected as follows. The i-th output port of WSS 902; (where 1≦i≦N and 1≦j≦N) is connected to the j-th input port of WSS 904ₖ (where 1≦k≦N). For example, each of the output ports of WSS 902₁ is connected to the first input port of the corresponding WSS 904. Each of the output ports of WSS 902₂ is connected to the second input port of the corresponding WSS 904. Each of the output ports of WSS 902₃ is connected to the third input port of the corresponding WSS 904, etc.

FIG. 10 shows a block diagram of a 1×N wavelength-selective switch (WSS) 1002 that can be used as WSS 902 according to one embodiment of the invention. An optical input signal 1008 received by WSS 1002 is applied to an optical demultiplexer (DEMUX) 1010 having one input port and K output ports, where K is an integer greater than 1 and preferably greater than N−1 (e.g., K=N). Each of the output ports is coupled to a corresponding “regular” (as opposed to wavelength-selective) 1×N switch 1014. By the term “regular,” it is meant that switch 1014 is adapted to route an input optical signal received at its input port to a selected one of its output ports. A control signal 1012 determines the output port selection for each switch 1014. The output ports of switches 1014 are coupled to the input ports of N optical multiplexers (MUXes) 1018, each having K input ports and one output port. More specifically, the first output ports of switches 1014 are coupled to the corresponding input ports of MUX 1018₁. The second output ports of switches 1014 are coupled to the corresponding input ports of MUX 1018₂, etc. The N-th output ports of switches 1014 are coupled to the corresponding input ports of MUX 1018_{N}. The N output ports of MUXes 1018₁-1018_{N} serve as output ports of WSS 1002.

In one embodiment, each of DEMUX 1010 and MUXes 1018₁-1018_{N} represents a separate instance of the same physical device. The device has K ports at its first side and one port at its second side. To implement any of MUXes 1018₁-1018_{N}, the device is configured so that the K ports at the first side serve as input ports and the single port at the second side serves as an output port. To implement DEMUX 1010, the device is configured so that the single port at the second side serves as an input port and the K ports at the first side serve as output ports.

By reconfiguring switches 1014, WSS 1002 can direct any selection (including all) of the spectral components of input signal 1008 to any selected output port. For example, to direct a k-th spectral component of signal 1008 to the n-th output port of WSS 1002 (where 1≦k≦K and 1≦n≦N), switch 1018ₖ is configured to connect its input port to its n-th output port. MUX 1018ₙ then multiplexes all of the spectral components applied by switches 1014 to that MUX and presents them at the n-th output port of WSS 1002 as parts of the corresponding wavelength-multiplexed output signal.

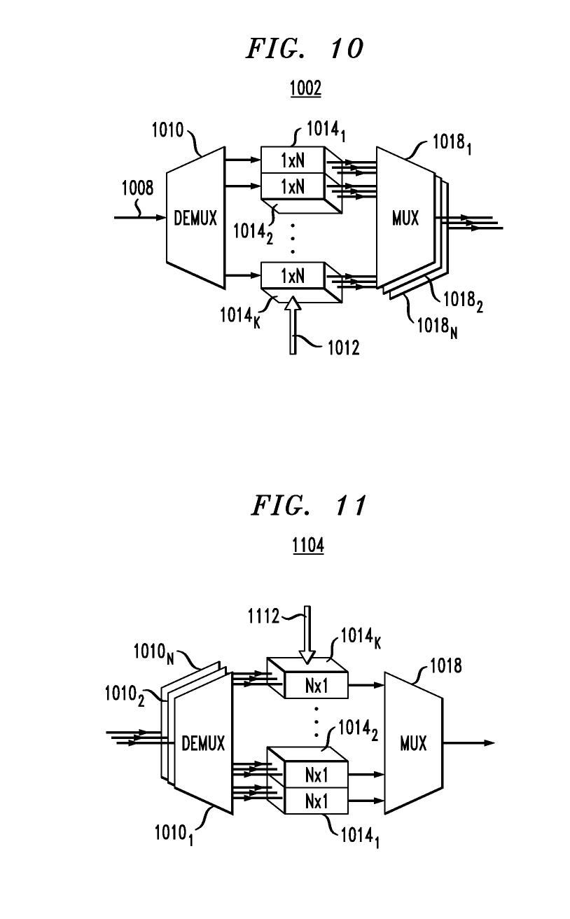

FIG. 11 shows a block diagram of an N×1 WSS 1104 that can be used as WSS 904 according to one embodiment of the invention. WSS 1104 is generally analogous to WSS 1002 of FIG. 10 and is constructed using many of the same optical components. A control signal 1112 is used to configure each of switches 1014₁-1014_{K} so that an appropriate one of DEMUXes 1010₁-1010_{N} is connected to the appropriate input port of MUX 1018. MUX 1018 multiplexes all of the spectral components applied by switches 1014 to that MUX and presents them at the output port of WSS 1002 as parts of the corresponding wavelength-multiplexed output signal.

In one embodiment, WSSs 1002 and 1104 represent separate instances of the same physical device having N ports at its first side and one port at its second side. To implement WSS 1002, the device is configured so that the single port at the second side serves as an input port and the N ports at the first side serve as output ports. To implement WSS 1104, the device is configured so that the N ports at the first side serve as input ports and the single port at the second side serves as an output port.

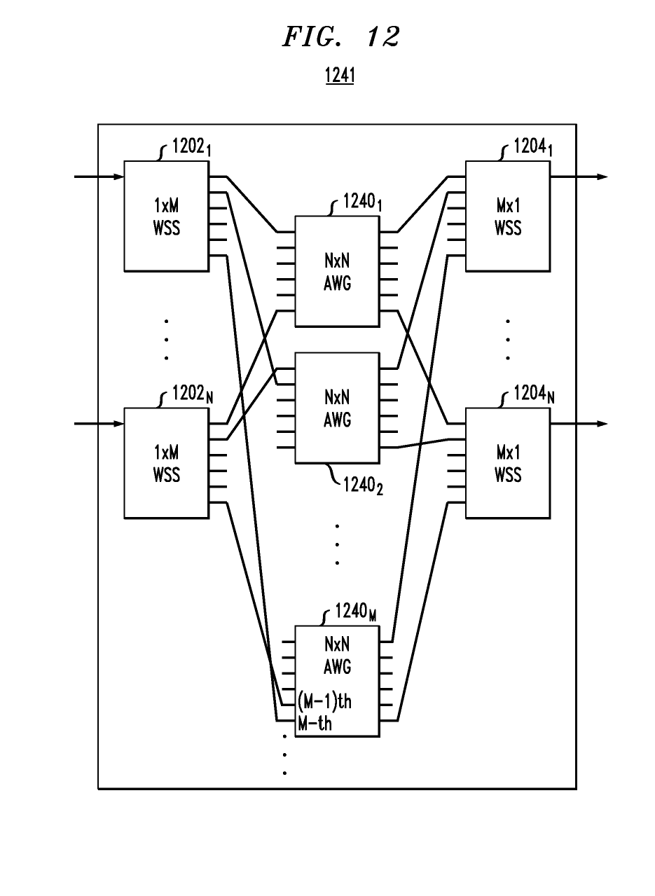

FIG. 12 shows a block diagram of a wavelength-routed network 1241 that can be used in an N×N scalable load-balanced interconnect switch according to one embodiment of the invention. Network 1241 is generally analogous to network 540 (FIG. 5) and is constructed of (i) N 1×M WSSs 1202₁-1202_{N}, (ii) M N×N AWGs 1240₁-1240_{M}, and (iii) N M×1 WSSs 1204₁-1204_{N}, where M is an integer greater than 1. The components of network 1241 are interconnected as further described below. In one embodiment, each WSS 1202, AWG 1240, and WSS 1204 is implemented using WSS 1002 (FIG. 10), AWG 840 (FIG. 8), and WSS 1104 (FIG. 11), respectively.

Each output port of WSS 1202 is connected to a sequentially shifted input port of the corresponding AWG 1240. For example, for WSS 1202₁, the first output port is connected to the first input port of AWG 1240₁; the second output port is connected to the second input port of AWG 1240₂, and so on until the M-th output port is connected to the M-th input port of AWG 1240_{M}. For WSS 1202₂, the first output port is connected to the second input port of AWG 1240₁; the second output port is connected to the third input port of AWG 1240₂, etc.; the M-th output port is connected to the (M+1)-th input port of AWG 1240_{M}. For WSS 1202_{N}, the first output port is connected to the N-th input port of AWG 1240₁; the second output port is connected to the first input port of AWG 1240₂, etc.; the M-th output port is connected to the (M−1)-th input port of AWG 1240_{M}. The following recursive formula can be used to generalize these connections: if an m-th output port of a 1×M WSS is connected to a k-th input port of an l-th AWG, then a Mod (m+1, M)-th output port of that 1×M WSS is connected to a Mod (k+1, N)-th input port of a Mod (l+1, M)-th AWG, where 1≦m≦M, 1≦k≦N, and 1≦l≦M.

Each input port of WSS 1204ᵢ is connected to the i-th output port of the corresponding AWG 1240. For example, for WSS 1204₁, the first input port is connected to the first output port of AWG 1240₁; the second input port is connected to the first output port of AWG 1240₂, etc.; the M-th input port is connected to the first output port of AWG 1240_{M}. For WSS 1204₂, the first input port is connected to the second output port of AWG 1240₁; the second input port is connected to the second output port of AWG 1240₂, etc.; the M-th input port is connected to the second output port of AWG 1240_{M}. For WSS 1204_{N}, the first input port is connected to the N-th output port of AWG 1240₁; the second input port is connected to the N-th output port of AWG 1240₂; . . . the M-th input port is connected to the N-th output port of AWG 1240_{M}.

### Scalability

For appropriate load balancing, it is preferred that, in a partially deployed implementation of a load-balanced interconnect switch of the invention, the total capacity of the deployed input line cards does not exceed the total capacity of the deployed output line cards. It is further preferred that, with a fixed number of line cards, the configuration of the optical switch fabric (e.g., AWG 140, AWG 840, bank 340, bank 940, network 540, or network 1241) in the switch remains static (i.e., fixed) and needs to be changed only if and when the number of deployed and/or operational line cards changes. The latter preference imposes certain restrictions on the possible combinations of input and output line cards with which the switch can achieve complete load balancing. For example, assuming that each of the deployed line cards operates at full capacity, partially deployed implementations of switch 100 (FIG. 1) can statically achieve complete load balancing with the following combinations of input/output line cards: 1/4, 2/4, 3/4, 1/2, 2/2, and 1/1. To achieve complete load balancing with any of the remaining combinations of input/output line cards, one or more of the following may need to be implemented: (1) reducing the capacity of one or more of the line cards, e.g., by shutting down one or more lasers analogous to lasers 702 (FIG. 7A) and/or one or more PDs analogous to PDs 762 (FIG. 7B); (2) dynamically reconfiguring the optical switch fabric in the course of data transmission; and (3) dynamically retuning one or more of the lasers in one or more of the input line cards in the course of data transmission. Alternatively, a static configuration that results in only “partial” load balancing can be employed with those remaining combinations. The following description further illustrates (i) representative dynamic configurations for complete load balancing in exemplary partially deployed implementations of switch 100 and (2) representative static configurations for “partial” load balancing.

Referring back to FIG. 2B, if output line card 160c is added to the implementation of switch 100 shown therein, then the following exemplary dynamic configuration can be employed. The first three lasers of input line card 120a are configured to generate wavelengths λ₁, λ₂, and λ₃, respectively. The fourth laser is periodically tuned to wavelengths λ₅, λ₆, and λ₇ so that, on average, equal time is spent on each of these wavelengths. Two filters 156 in DEMUX 150a are tuned so that those filters transmit the signal components corresponding to wavelengths λ₁ and λ₅, respectively, while the remaining two filters block those components. Two filters 156 in DEMUX 150b are tuned so that those filters transmit the signal components corresponding to wavelengths λ₂ and λ₆, respectively, while the remaining two filters block those components. Two filters 156 in DEMUX 150c are tuned so that those filters transmit the signal components corresponding to wavelengths λ₃ and λ₇, respectively, while the remaining two filters block those components. Assuming that input line card 120a evenly distributes (i) three quarters of the incoming data units amongst wavelengths λ₁, λ₂, and λ₃ and (ii) the remaining quarter of the incoming data units between wavelengths λ₅, λ₆, and λ₇, each of output line cards 160a-c will receive one third of the total traffic, hence complete load balancing. Note that this dynamic configuration relies on the ability of the fourth laser to quickly tune its output wavelength without causing significant downtime or interruptions in the flow of traffic through switch 100.

Alternatively, the output wavelength of the fourth laser can be fixed, e.g., at λ₅. The resulting static configuration will still spread the traffic load between output line cards 160a-c. However, output line card 160a will receive more traffic than either one of output line cards 160b-c, hence only “partial” load balancing. This static configuration might be useful in situations where deviations from complete load balancing are acceptable.

Referring back to FIG. 4B, if output line card 160c is added to the implementation of switch 100′ shown therein, then WSS 302a is configured as follows. The spectral components of wavelength-multiplexed signal 132a corresponding to wavelengths λ₁, λ₂, and λ₃ are directed to WSSs 302-I, 302-II, and 302-III, respectively. The spectral component of wavelength-multiplexed signal 132a corresponding to wavelengths λ₄ is rerouted in a cyclical manner so that, on average, that component is being directed equal amounts of time to each of WSSs 302-I, 302-II, and 302-III. Two filters 156 in DEMUX 150a are tuned so that those filters transmit the signal components corresponding to wavelengths λ₁ and λ₄, respectively, while the remaining two filters block those components. Two filters 156 in DEMUX 150b are tuned so that those filters transmit the signal components corresponding to wavelengths λ₂ and λ₄, respectively, while the remaining two filters block those components. Two filters 156 in DEMUX 150c are tuned so that those filters transmit the signal components corresponding to wavelengths λ₃ and λ₄, respectively, while the remaining two filters block those components. Assuming that input line card 120a evenly distributes the incoming data units amongst its four wavelengths, each of output line cards 160a-c will receive one third of the total traffic, hence complete load balancing. Note that this dynamic configuration relies on the ability of WSS 302a to quickly change its routing configuration without causing significant downtime or interruptions in the flow of traffic through switch 100′.

Alternatively, the configuration of WSS 302a can be fixed, e.g., so that the signal component of wavelength-multiplexed signal 132a corresponding to wavelengths λ₄ is directed to WSS 302-I. The resulting static configuration will still spread the traffic load between output line cards 160a-c. However, output line card 160a will receive more traffic than either one of output line cards 160b-c, hence only “partial” load balancing.

The scalability of load-balanced interconnect switches of the invention further depends on the tunability range of the lasers, e.g., lasers 702 (FIG. 7A), employed in the input line cards. For example, an N×N load-balanced interconnect switch employing AWG 840 (FIG. 8) can fully realize its scalability potential if those lasers are able to provide N carrier wavelengths. If the lasers provide fewer than N² carrier wavelengths, then the switch might not be able to provide load balancing in certain otherwise eligible partially deployed implementations. In general, if there is a relative scarcity of accessible carrier wavelengths, then the switch architecture represented by FIGS. 5, 6, and 12 will support more different load-balanced partially deployed implementations than either one of the switch architectures represented by (i) FIGS. 1, 2, and 8 and (ii) FIGS. 3, 4, and 9, respectively.

While this invention has been described with reference to illustrative embodiments, this description is not intended to be construed in a limiting sense. For example, carrier wavelengths generated by an input line card can correspond to any selected diffraction order of the AWG. WSS 1104 can be used to implement signal combiner 130. WSS 1002 can be used to implement DEMUX 150. Although certain embodiments of load-balanced interconnect switches of the invention have been described in reference to cyclical AWGs, other types (e.g., non-cyclical) of AWGs can also be used. Other (de)multiplexers such as free space coupled gratings with multiple orders or periodic responses can similarly be used. Various modifications of the described embodiments, as well as other embodiments of the invention, which are apparent to persons skilled in the art to which the invention pertains are deemed to lie within the principle and scope of the invention as expressed in the following claims.

As used in the specification and claims, the term optical switch fabric (OSF) generally refers to an optical interconnect mesh used in a load-balanced interconnect switch to optically couple input and output line cards. For example, each of AWG 140, AWG 840, bank 340, bank 940, network 540, and network 1241 is an OSF. Since an interconnect switch of the invention uses optical fiber to couple input and output cards to the OSF and, in certain embodiments, to couple different components of the OSF to each other, one skilled in the art will appreciate that various components of the interconnect switch may be distributed over a relatively large geographical area and/or separated from each other by significant distances (e.g., larger than about 1 km).

It should be appreciated that complete load balancing has two different aspects. On one hand, from the standpoint of an input line card, e.g., line card 120, complete load balancing means that the input line card evenly distributes its outgoing traffic between different deployed/workable output line cards, e.g., line cards 160. On the other hand, from the standpoint of an output line card, complete load balancing means that the line card receives equal shares of its incoming traffic from different deployed/workable input line cards. For a partially-deployed switch implementation, the total number of lasers in the input line cards might not be an integer multiple of the number of output line cards. For example, if switch 100 has one input line card 120 and three output line cards 160, then the total number of lasers is four, which is not an integer multiple of three. If input line card 120 is configured to operate at full capacity, then switch 100 can only achieve partial load balancing because, at any instance in time, one of the three output line cards 160 will receive more data than each of the other two output line cards. Furthermore, even if the physical structure of the partially-deployed switch implementation is capable of supporting complete load balancing, the operator may still deliberately choose to operate the interconnect switch in a partial load-balancing mode rather than a complete load-balancing mode. Unless explicitly specified otherwise, the terms “load balancing” and “load-balanced” cover both complete and partial load balancing.

For a diffraction grating, a single wavelength can simultaneously have multiple discrete diffraction angles. These different angles are said to belong to different diffraction orders of the grating. If the diffraction grating receives multicolored light, then different diffraction orders of the grating place the corresponding spectrally dispersed portions of the received light into differently positioned angular or spatial segments. If the light-acceptance aperture of the detector is fixed in space, then each diffraction order delivers a different respective spectral portion of the light to the detector. Because each of output ports I-IV of AWG 140 functions as an acceptance aperture for the corresponding detector, e.g., output line card 160, the AWG can simultaneously direct different wavelengths corresponding to different diffraction orders of the AWG to any particular output line card. For example, port I of AWG 140 can receive wavelength λ₁ corresponding to the first diffraction order of the AWG and wavelength λ₅ corresponding to the second diffraction order of the AWG, as shown in FIG. 2B.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels (if any) in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. An optical interconnect switch, comprising:
an optical switch fabric (OSF) having N input ports and N output ports, where N is an integer greater than one, said OSF comprising:
N 1×M wavelength-selective switches (WSSs), where M is an integer greater than one;
N M×1 WSSs optically coupled to the N 1×M WSSs, wherein:
each of said 1×M WSSs has an input port and M output ports, wherein the input ports of said N 1×M WSSs are the N input ports of the OSF;
each of said M×1 WSSs has M input ports and an output port, wherein the output ports of said N 1×M WSSs are the N output ports of the OSF; and
said OSF is adapted to route optical signals from said input ports to said output ports;
one or more input line cards, each optically coupled to a corresponding input port of the OSF and adapted to generate up to N respective modulated optical signals based on a respective incoming signal, said up to N modulated optical signals being multiplexed and applied to said corresponding input port; and
one or more output line cards, each optically coupled to a corresponding output port of the OSF and adapted to receive a respective optical output signal from said corresponding output port, said optical output signal having one or more spectral components corresponding to the multiplexed optical signals applied to the input ports of the OSF by said one or more input line cards.

2. The invention of claim 1, wherein each of said N 1×M WSSs is adapted to receive M spectral components at the WSS's input port and distribute said received spectral components in any selected manner between the M output ports.

3. The invention of claim 2, wherein each of said N 1×M WSSs comprises:
an optical demultiplexer (DEMUX) having an input port and K output ports, where K is an integer greater than 1, wherein said input port of the DEMUX is the input port of the WSS;
K 1×M switches, each having an input port and M output ports and adapted to route an input optical signal received at the input port to a selected one of said M output ports; and
M optical multiplexers (MUXes), each having K input ports and an output port, each of said K input ports connected to a different output port of a respective one of said K 1×M switches, wherein the output ports of the M MUXes are the output ports of the WSS.

4. The invention of claim 1, wherein each of said N M×1 WSSs is adapted to receive M spectral components distributed in any selected manner between the M input ports and direct said M received spectral components to the WSS's output port.

5. The invention of claim 4, wherein each of said N M×1 WSSs comprises:
M optical demultiplexers (DEMUXes), each having an input port and K output ports, wherein the input ports of the M DEMUXes are the input ports of the WSS;
K M×1 switches, each having M input ports and an output port and adapted to route an input optical signal received at a selected input port to said output port, wherein each of said M input ports is connected to an output port of a respective different of said M DEMUXes; and
an optical multiplexer (MUX) having K input ports and an output port, each of said K input ports connected to the output port of a respective one of said K M×1 switches, wherein the output port of the MUX is the output port of the WSS.

6. The invention of claim 1, wherein the optical interconnect switch is adapted to support load balancing.

7. The invention of claim 6, wherein:
said one or more output line cards comprise at least two output line cards; and
for at least one of said one or more input line cards, the optical interconnect switch evenly distributes outgoing data traffic among said at least two output line cards.

8. The invention of claim 6, wherein:
said one or more input line cards comprise at least two input line cards; and
at least one of said one or more output line cards receives equal shares of incoming data traffic from different of said at least two input line cards.

9. The invention of claim 6, wherein:
the optical interconnect switch has fewer than N input line cards and fewer than N output line cards; and
each of the input line cards operates at full transmit capacity.

10. The invention of claim 1, wherein each of said one or more output line cards is adapted to (i) decode the received one or more spectral components to recover data modulated thereupon and (ii) generate an outgoing electrical signal based on the recovered data.

11. The invention of claim 1, wherein M=N and each output port of a k-th 1×M WSS is directly connected to a k-th input port of a respective M×1 WSS, where 1≦k≦N.

12. The invention of claim 1, wherein the OSF further comprises M N×N arrayed waveguide gratings (AWGs) optically coupled between the output ports of said N 1×M WSSs and the input ports of said N M×1 WSSs.

13. The invention of claim 12, wherein:
each of said M AWGs has N input ports and N output ports;
each of the output ports of each of said N 1×M WSS is connected to one of the input ports of a respective one of said M AWGs, wherein, if an m-th output port of a 1×M WSS is connected to a k-th input port of an l-th AWG, then a Mod (m+1, M)-th output port of said 1×M WSS is connected to a Mod (k+1, N)-th input port of a Mod (l+1, M)-th AWG, where 1≦m≦M, 1≦k≦N, and 1≦l≦M; and
each of the input ports of an i-th M×1 WSS is connected to an i-th output port of a respective one of said M AWGs, where 1≦i≦M.

14. The invention of claim 1, wherein respective routing configurations of said N 1×M WSSs and said N M×1 WSSs are static during data transmission through the optical interconnect switch.

15. The invention of claim 1, wherein the optical interconnect switch is adapted to change at least one of respective routing configurations of said N 1×M WSSs and said N M×1 WSSs during data transmission through the optical interconnect switch to change a destination output line card for at least one of the modulated optical signals.

16. A method for routing signals, comprising the steps of:
at each of one or more selected input ports of an optical switch fabric (OSF),
generating up to N respective modulated optical signals based on a respective incoming signal, where N is an integer greater than one, wherein the OSF has N input ports and N output ports and comprises:
N 1×M wavelength-selective switches (WSSs), where M is an integer greater than one;
N M×1 WSSs optically coupled to the N 1×M WSSs, wherein:
each of said 1×M WSSs has an input port and M output ports, wherein the input ports of said N 1×M WSSs are the N input ports of the OSF;
each of said M×1 WSSs has M input ports and an output port, wherein the output ports of said N 1×M WSSs are the N output ports of the OSF; and
said OSF adapted to route optical signals from said input ports to said output ports;
multiplexing said up to N modulated optical signals into a corresponding multiplexed optical signal; and
applying the multiplexed optical signal to the input port;
routing the one or more multiplexed optical signals from the corresponding one or more input ports to one or more selected output ports of the OSF; and
at each of said one or more selected output ports, receiving a respective optical output signal having one or more modulated optical signals corresponding to the one or more multiplexed optical signals.

17. The invention of claim 16, further comprising the step of balancing traffic load across the OSF.

18. The invention of claim 16, further comprising the step of, for at least one of said WSSs, dynamically changing the WSS's routing configuration in the course of data transmission to change a destination output port for at least one of the modulated optical signals.

19. The invention of claim 16, wherein:
each of said selected input ports has a respective optically coupled input line card that generates said up to N modulated optical signals;
each of said selected output ports has a respective optically coupled output line card that receives said respective optical output signal; and
the method further comprises the step of changing at least one of (i) a total number of the input line cards and (ii) a total number of the output line cards.

20. The invention of claim 19, further comprising the steps of:
changing a routing configuration of at least one WSS after said change; and
keeping the routing configurations of the WSSs fixed until a next change of at least one of said total numbers.
